(19) United States
(12) Patent Application Publication
(10) Pub. No.: US 2007/0056324 A1
(43) Pub. Date: Mar. 15, 2007

(54) Method and device for bending glass sheets

(75) Inventors: Werner Diederen, Herzogenrath (DE); Arnaud Borderiou, Eupen (BE); Thomas Meissen, Baesweiler (DE); Herbert Radermarcher, Raeren (BE); Stefan Reckers, Aachen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/551,090

(22) PCT Filed: Mar. 26, 2004
(86) PCT No.: PCT/FR04/00763

§ 371 Date: Nov. 14, 2006

(30) Foreign Application Priority Data
Mar. 29, 2003 (DE) 103 14 267.3

(51) Int. Cl. C03B 31/00; C03B 23/02; C03B 23/00

(52) U.S. Cl. 65/106; 65/287

(57) ABSTRACT

A method of bending glass panes heated to their softening temperature in the horizontal position. The panes are heated to their bending temperature in a furnace. The panes are brought between a concave bending frame having shaping surfaces that describe a smaller contour than dimensions of the panes, and a convex upper form with a solid surface. The panes are pressed between the bending frame and the upper form so that the panes assume, at least at certain points, the contour of the upper form. A ring-shaped final-bending frame having shaping surfaces that correspond to the final shape of the panes is brought into contact with the protruding marginal regions of the panes, and the panes are pressed against the upper form. The panes on which the bending operation has been completed are subjected to a cooling or quenching treatment.

The invention relates to a method of bending glass panes, in which prebending is carried out in the horizontal position, using a convex upper form with a solid surface, on a bending frame and the bending operation on the panes is then finished with the aid of a final-bending frame acting on the prebent panes. The invention also refers to a device adapted in particular to implementing this method.

Methods of bending panes in the horizontal position are widespread. Conventionally, the panes are compressed to the desired shape between an upper form with a solid surface and a rigid bending support in the form of a frame. If the bending radii of the panes exceed a certain value, the dimensional or optical quality requirements can often no longer be met with such a simple device; in particular, the optical quality suffers greatly because the surfaces of the glass are damaged as a result of considerable relative movements between the panes and the shaping tools. Moreover, that may lead to sagging and wrinkling, making a pane manufactured in this way unusable as safety glass, for example in motor vehicles. This sagging appears if the pane is shaped, and thus deposited on the shaping surface of the equipment, in an uncontrolled manner.

A series of use solutions is known for avoiding these disadvantages. For example, document EP 0 411 032 B1 proposes equipping the upper form with a number of suction chambers which open into a multitude of suction bores in the shaping surface coming into contact with the pane. The various suction chambers, one for the central region of the pane and one for each of the highly curved lateral regions, may have different negative pressures acting on them. It must thus be ensured that the central region of the pane remains in contact with the upper form when the lateral regions are compressed between the upper form by the bending frame.

Another means for overcoming the difficulties described above has been sought through a multipart design of the bending forms in the form of frames acting as dies. This is to allow a certain region of the pane to be initially bent and fixed to a convex bending form with a solid surface. The bending operation on the pane is then finished by pivoting another shaping part against the pane and driving the latter until it touches the negative die. When such multipart bending forms are used, under certain circumstances there may occur irregularities in the orientation of the bending in the region of the articulations because the shaping surface of the bending forms in the form of frames is interrupted there. These disadvantages have been observed in particular in the case of small bending radii and when the glass has too high or too low a temperature. Documents DE 38 03 575 A1 and DE 35 27 558 A1 for example are concerned with improving multipart bending forms of this type.

Document DE 38 03 575 A1 refers to a method of bending a pane having regions which are bent through small bending angles. The bending equipment used is a bending press comprising a punch and a die, the die consisting of at least two shaping parts connected to one another in an articulated manner. Once the bending press has touched part of the pane heated to the bending temperature, at least one pivotable shaping part of the die is turned about the pivot axis against the punch. An adjustable electric motor acts as a drive motor for moving the pivotable shaping parts. The angular velocity of the pivoting movement of the pivotable shaping parts during the bending operation is adjusted according to the temperature of the pane and the degree of deformation.

Another means of overcoming the above-described difficulties is described in document DE 35 27 558 A1. In this bending method, a pane heated to the bending temperature is touched by a multipart bending form whose various shaping parts are connected to one another in an articulated manner and is bent by pivoting the shaping parts connected in an articulated manner to the central shaping part so as to obtain the desired shape. The pivot pins of the pivotable shaping parts are guided during pivoting in guide slots along curved tracks which have been determined according to the desired shape of the pane. The shaping frames of the pivotable shaping parts are thus rolled progressively on the pane and the pane is compressed, without relative sliding movement with respect to the bending forms, progressively against the shaping surface of the punch.

The aim of the invention is to specify another method of bending panes and also a device adapted for its implementation.

This aim is achieved as regards the method according to the invention by virtue of the characteristics of claim 1. The characteristics of claim 9 indicate a suitable device. The characteristics of the secondary claims respectively dependent on the independent claims indicate advantageous improvements of these objectives.

In the bending method according to the invention, shaping of the panes heated to their softening temperature takes place in two successive press-bending steps with the aid of two independent bending frames with concave shaping surfaces (dies) which cooperate with a convex upper form with a solid surface and press the pane between them. The bending frame for the first press-bending step has a contour which is smaller than the final-bending frame for the second press-bending step. The bending frame can be guided through the opening within the shaping surfaces of the final-bending frame.

The method can be applied equally well to panes to be bent individually and to a plurality of panes to be bent simultaneously (for the manufacture of curved composite panes).

Once the panes have been positioned between the bending frame and the upper form, the bending frame, in the first press-bending step, does not touch the panes in their outermost marginal region, but touches the surface of the panes further inward. The panes are compressed in their central region against the upper form and assume there approximately the contour of the upper form. Before they are compressed, the panes may either be deposited on the bending frame or be transferred directly by a conveyor to the upper form and be held on the shaping surface by means of the differential pressure. The differential pressure may, for example, be generated by sucking in air through openings in the shaping surface of the upper form. However, it is also possible, in a manner known per se, to make use of a stream of (hot) gas directed against the upper form on that surface of the panes facing away from the shaping surface.

The bending frame may have a closed, ring-shaped shaping surface, but it is also possible to limit its shaping surfaces coming into contact with the surface of the glass to certain regions to be bent.

While the panes are held by the bending frame on the upper form, the final-bending frame acts on the free outer marginal regions (i.e. “protruding” or outwardly projecting regions with respect to the bending frame) of the pane (at the lower level) and presses them against the upper form. In this way, the desired final tangential angles may be produced very accurately, sagging of the panes within the region circumscribed by the bending frame being excluded at the same time. The shaping surfaces of the upper form and of the final-bending frame are generally designed to complement one another, the shaping surface of the bending frame having, however, to be restricted to its prebending and fixing function.

All the shaping surfaces which come into contact with the hot panes are of course machined in a conventional manner and/or provided with a heat-resistant material or fabric and/or with a suitable coating.

Once the panes have received their final shape, they can be conveyed from the final-bending frame to a cooling or prestressing (quenching) section. To this end, it is expedient to remove the upper form and the bending frame from the surfaces of the glass. Another conveying device can now take the bent panes from the final-bending frame. However, it is also possible to lift the pane from the upper form by means of the differential pressure which is generated, for example, by a vacuum device in order to remove it from the final-bending frame and transfer it to another conveying device.

In another configuration of the method, the final-bending frame itself may act as a conveying means and leave the bending area with the panes and then convey them to another treatment location.

In the case where the final-bending frame itself is the conveying means, the final-bending frame may particularly advantageously be designed as a prestressing, i.e. quenching, frame. This dispenses with at least one other conveying means and a separate quenching frame.

The two press-bending steps may additionally be assisted by providing a negative pressure-generating device in the upper form. If, during compression, the surface of the pane is at the same time sucked in toward the shaping surface of the upper form, it is thus possible to achieve particularly good bending orientation especially of the surface of the pane.

In an advantageous configuration of the invention, the final-bending frame may also be made of multiple parts, one or more shaping parts being able to pivot. The stationary shaping part is in this case first of all brought into contact with the pane. The moveable shaping parts can then be pivoted against the upper form. In this variant of the method according to the invention, the pane is fixed at other points, while the regions of greatest curvature, generally the terminal tangents, are compressed on the upper form.

Other details and advantages of the subject of the invention will emerge, without any limitation being intended, from the graphical representation of the various phases for implementing the method in a suitable device and from the detailed description below.

In a simplified basic representation,

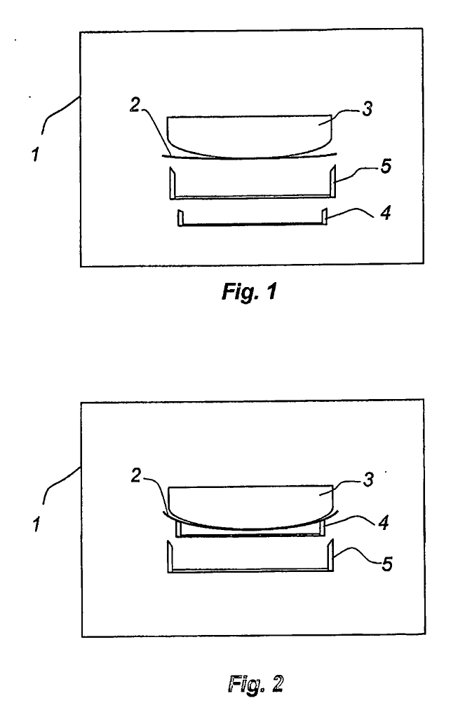

FIG. 1 shows the bending device just after the transfer of the pane to the convex upper form,

FIG. 2 shows the first pressing operation with the bending frame,

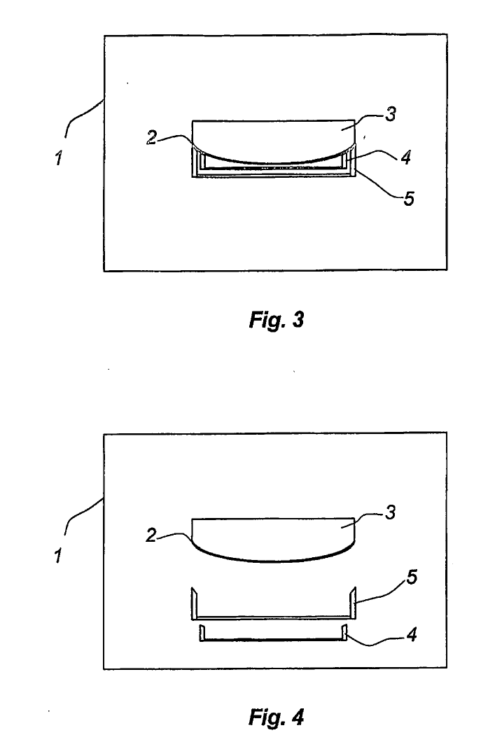

FIG. 3 shows the second pressing operation with the final-bending frame, and

FIG. 4 shows the pane after the pressing operation before being transferred from the upper form to a conveying device.

FIG. 1 shows, in a bending station 1 indicated by a box, a pane 2 heated to bending temperature and transferred from a conveying device (not shown) to an upper form 3 with a solid surface comprising a convex shaping surface. The pane 2 is held in a manner known per se with the aid of a negative pressure on the upper form 3 and is already slightly preformed by virtue of the differential pressure forces acting against the force of gravity. The means for generating the negative pressure are not depicted here for reasons of simplification, and it can be conceived of these including, for example, numerous air ducts distributed over the surface of the upper form and through which air from the bending station 1 or from the space between the upper form 3 and the pane 2 is sucked in. The atmospheric pressure prevailing under the softened pane 2 pushes the pane upward in the direction of the shaping surface even in its marginal regions.

Situated under the upper form 3 are the ring-shaped bending frame 4 and the likewise ring-shaped final-bending frame 5. Both bending frames have concave shaping surfaces. The outer contour of the bending frame 4 is slightly smaller than the free space circumscribed by the final-bending frame 5, with the result that the bending frame 4 can be guided through the free space mentioned.

The upper form 3 and the two bending frames 4, 5 are able to move with respect to one another and independently of one another. The corresponding drive means are not shown here; suitable devices and controls form part of the prior art and are not important for the embodiment described here.

As can be seen in FIG. 2, the bending frame 4 for the first pressing operation or press-bending step is moved through the final-bending frame 5 toward the upper form 3 until the central region of the pane 2 comes into contact with the upper form 3 and is fixed there. It is true that the pane 2 is already partially prebent, but its marginal regions have not yet assumed the desired final tangential angle predefined by the surface of the upper form 3. It is possible to maintain, reduce or else stop the negative pressure acting on the pane 2 as required following compression by the bending frame in the first bending step.

The second pressing operation which gives the pane 2 its final shape is represented in FIG. 3. In order for the pane 2 fixed to the upper form 3 across the bending frame 4 to be compressed against the shaping surface of the upper form 3 even in its regions having the highest curvature, the final-bending frame 5 is moved in the direction of the upper form 3, thereby touching the peripheral regions of the pane 2 and compressing them against the upper form 3. At the same time, the bending frame 4 remains in its position and holds the pane 2 on the upper form 3 in such a way that the pane 2 is unable to sag toward the center of the pane during the pressing operation by the bending frame 5. As the free space within the shaping surfaces of the final-bending frame 5 is slightly greater than the external dimensions of the bending frame 4, the final-bending frame 5 can be guided with free passage on all sides as it passes through the bending frame 4 toward the upper form 3.

FIG. 4 represents the final phase of the bending method, in which the two bending frames 4, 5 are separated from the upper form 3, and the pane 2, the bending operation on which has been completed, is held on the lower face of the upper form 3 by means of a negative pressure acting on the pane 2 originating from the upper form 3 which, where appropriate, now has to be reinstalled. In this phase of the bending method, a conveying device or a prestressing (quenching) frame may enter the bending station 1 from the side and take the pane 2 from the bending form 3, then convey it to another treatment location.

The directions of movement of the various components 3, 4, 5 of the device can of course be changed as desired with respect to one another. For example, the press-bending steps can also be carried out by lowering the upper form 3 toward the bending frames 4, 5, and it is also possible to carry out one press-bending step by raising a bending frame and the other press-bending step by lowering the bending form 3. It is crucial for the method that the pane is preformed during a first press-bending step and that its central region is fixed to the upper form, while, in the second press-bending step, with the pane remaining fixed, the marginal regions of the pane are bent by means of another bending frame against the shaping surface of the upper form in order to give them their final shape.

1-14. (canceled)

15. A method of bending glass panes heated to their softening temperature in a horizontal position, comprising:
heating the panes to their bending temperature in a furnace;
bringing the panes between a concave bending frame, having shaping surfaces that describe a smaller contour than external dimensions of the panes, and a convex upper form with a solid surface;
pressing the panes between the bending frame and the upper form so that the panes assume, at least at certain points, the contour of the upper form, as a first press-bending;
bringing a frame-shaped final-bending frame, having shaping surfaces that correspond to a final shape of the panes, into contact with protruding marginal regions of the panes, and pressing the panes against the upper form, as a second press-bending; and
subjecting the panes on which the bending operation has been completed to a cooling or quenching treatment.

16. The method as claimed in claim 15, wherein the bending frame remains compressed during the second press-bending.

17. The method as claimed in claim 15, wherein the bending frame and the upper form are removed from the panes after the second press-bending and the panes are conveyed to the cooling or quenching treatment location with aid of the final-bending frame.

18. The method as claimed in claim 17, wherein the final-bending frame serves as a quenching frame.

19. The method as claimed in claim 15, wherein:
the bending frame and the final-bending frame are removed from the panes after the second press-bending;
the panes are held by differential pressure on the upper form;
the panes are deposited from the upper form onto a conveying device; and
the panes are conveyed by the conveying device to a location of the cooling or quenching treatment.

20. The method as claimed in claim 19, wherein the conveying device is a quenching frame on which the panes are pre-stressed.

21. The method as claimed in claim 15, wherein at least one of the first or second press-bending is assisted by differential pressure.

22. The method as claimed in claim 15, wherein the final-bending frame used is a multipart bending frame and final bending is achieved by pivoting one or more parts of the bending frame.

23. A device for bending panes heated to their softening temperature, comprising:
a furnace for heating the panes;
a concave bending frame for pre-forming the heated panes;
a convex upper form with a solid surface;
a frame-shaped final-bending frame with a concave shaping surface that substantially corresponds to the final shape of the panes;
means for moving the bending frame, the final-bending frame, and the upper form relative to one another; and
means for conveying the panes on which the bending operation has been completed to a cooling or quenching station.

24. The device as claimed in claim 23, wherein the bending frame has an outer contour that is smaller than the surface circumscribed by the final-bending frame, with a result that the final-bending frame can be guided through the bending frame and at a same time compressed therewith against the panes.

25. The device as claimed in claim 23, wherein the bending frame is provided with shaping surfaces that touch the panes only at certain points.

26. The device as claimed in claim 23, wherein the final-bending frame is configured as a quenching frame.

27. The device as claimed in claim 23, wherein the final-bending frame is configured as a multipart bending frame with pivotable shaping surfaces.

28. The device as claimed in claim 23, wherein the upper form includes means for generating a negative pressure between the shaping surface of the upper form and the surface of the panes extending above.
